(19) United States
(12) Patent Application Publication
(10) Pub. No.: US 2009/0172780 A1
(43) Pub. Date: Jul. 2, 2009

(54) Server for displaying contents

(75) Inventors: Hiroko Sukeda, Tokorozawa (JP); Youichi Horii, Mitaka (JP); Takeshi Hoshino, Kodaira (JP)

Correspondence Address: REED SMITH LLP, 3110 Fairview Park Drive, Suite 1400, Falls Church, VA, 22042, US

(73) Assignee: Hitachi, Ltd.

(21) Appl. No.: 12/314,887

(22) Filed: Dec. 18, 2008

(30) Foreign Application Priority Data
Dec. 26, 2007 (JP) 2007-333441

(51) Int. Cl. G06F 21/00

(52) U.S. Cl. 726/3

(57) ABSTRACT

Provided are a user/viewer-friendly device and system for displaying various contents such as moving images, still images, and texts, and a service using these. A screen (terminal) for displaying the contents and a terminal for operating display switching, etc. are separated from each other. A display terminal (television, large screen display, etc.) and an operation terminal (mobile phone terminal) are connected to a server through a network. The server manages association and operation of both the terminals.

### CLAIM OF PRIORITY

The present application claims priority from Japanese patent application JP 2007-333441 filed on Dec. 26, 2007, the content of which is hereby incorporated by reference into this application.

### BACKGROUND OF THE INVENTION

1. Field of the Invention

The present invention relates to a content display device and a display method for displaying various types of contents such as moving images, still images, audios and texts. The present invention particularly relates to a method for separating a terminal for display from a terminal for operation, and more specifically relates to: a method for controlling display switching in a display device in response to operation from a mobile terminal such as a mobile phone; a device in which the method is implemented; and a service using the device.

2. Description of the Related Art

Televisions (television sets, TV) are widely used and familiar to every household. In recent years, particularly, due to increase in channels and functions of a television, a user has been required to perform complicated operations for selecting one of recorded programs and broadcasting programs to be watched, and for selecting a channel from among many channels with reference to program information. Moreover, there has been an increasing demand for quick access to a content desired to be watched, from among various contents delivered from a network, program contents recorded in a recorder, and the like. Such quick access is carried out either by rearranging these contents by using as keys attached data (referred to as metadata) given to data on these contents, or by searching these contents with a keyword. In order to satisfy such a demand, a technique has been proposed in which a remote controller for operation itself is given high functionality, or in which a display of a menu on a TV screen facilitates execution of the complicated operation while reducing the number of operation buttons of the remote controller (see Japanese Patent Application Publication No. 2001-69369).

On the other hand, a service has been popular in which displays each having a comparatively large screen are installed in public (or semi-public) places such as the outdoors, shop fronts, or inside of trains, and various moving and still image contents such as news and advertisements are displayed on the displays. An object of this service is to effectively send information and provide advertisements and amusement contents to people who gather in such places and passersby therearound, by switching moving and still images depending on time and situation (see Japanese Patent No. 3936481).

### SUMMARY OF THE INVENTION

When high functionality is added to the remote controller to make it convenient to watch various moving image contents on television, the remote controller needs to have a large number of buttons, for example, and thereby requires complicated operations. This brings about a problem that it is difficult to perform intuitive operation on the remote controller. A possible method to avoid this problem is to reduce the number of the buttons of the remote controller, by displaying a menu on the TV screen and operating the displayed menu with the remote controller. However, this method has disadvantages that the menu display interferes with a program currently watched, or that it is difficult to find a desired function due to the hierarchical structure of the menu. Moreover, even if a user makes an effort to get accustomed to operating the remote controller, when the user buys a new television, the operation of the remote controller of the new television may be different from that of the old one. For this reason, the user cannot properly operate the remote controller for a desired purpose and may be puzzled. This also holds true when there are several devices (televisions, recorders, etc.) operated by the remote controller at home.

Moreover, as the service in which contents are displayed on a display of a public terminal, there has been also provided a service not only of unidirectionally distributing moving images and advertisements from a content provider, but also of allowing a general user to interactively operate the screen display by using a touch panel or the like. However, there are problems to be solved such as reluctance to directly touch the public terminal, hesitation in performing operation before a large screen, and unfamiliarity with how to operate. Consequently, under the present circumstances, it is hard to say that such interactive display service is utilized so effectively.

An object of the present invention is to provide a user/viewer-friendly device and system in a content display apparatus that displays various contents such as moving images, still images, and texts, and to provide a service by use of the device and the system.

In order to solve the above-mentioned problems, a screen (terminal) for displaying contents (display terminal) and a terminal for operating display switching or the like (operation terminal) are separated from each other. As a typical operation terminal, a mobile terminal such as a mobile phone is used. Here, the mobile phone is widely used and daily carried by a lot of people, and the people are accustomed to its operation. The display terminal (televisions, large screen displays, etc.) and the operation terminal (mobile phone terminal) are connected to a server via a network. By managing an association between the display terminal and the operation terminal as well as the operation of these terminals in the server, commands from the operation terminal are accumulated in the server. In response to the commands, the display terminal performs processing of display switching, volume control, or the like. In this system, since the operation terminal and the display terminal do not directly communicate with each other, the processing to associate both terminals in the server is important. Particularly, in a public terminal where a user is unknown, processing such as authentication of the operation terminal and management of an expiration date becomes necessary for the server.

A server for displaying contents according to the present invention includes: a data storing part that stores terminal association data that associates an operation terminal ID for identifying an operation terminal and a display terminal ID for identifying a display terminal; and display information in which in which the display terminal ID is associated with a content to be displayed on the display terminal; a data communication processing part that performs data communication with the operation terminal and the display terminal through a communication network; and a controller that performs authentication and access control of the operation terminal; wherein when there is access from the operation terminal, the controller authenticates the operation terminal with reference to terminal association data to acquire the display terminal ID associated with the operation terminal; in response to a command sent from the operation terminal, the controller stores the content to be displayed in association with the acquired display terminal ID; and when there is an inquiry from the display terminal, the controller sends to the display terminal the contents stored in association with the display terminal ID or a reference destination of the contents.

In the data storing part, content data and a distribution schedule for moving image display may be stored, and the number of times of valid operation by the operation terminal and/or ending time of use may be registered in the terminal association data.

Here, contents information sent to the display terminal from the server includes the reference destination of a digital content such as moving and still images (URL in many case), or a URL of a web page to be displayed.

Moreover, a server for displaying contents according to the present invention includes: a data storing part that stores terminal association data in which an operation terminal ID that identifies an operation terminal, a display terminal ID that identifies a display terminal, and a URL for access by the operation terminal are associated with one another, a URL of a search engine site, and data in which the display terminal ID and a keyword to be passed to the display terminal are associated with each other; a data communication processing part that performs data communication with the operation terminal and the display terminal through a communication network; and a controller that performs authentication and access control of the operation terminal; wherein when the operation terminal accesses the URL for access, the controller authenticates the operation terminal with reference to the terminal association data, and acquires the display terminal ID associated with the operation terminal; and when there is an inquiry from the display terminal, the controller sends the URL for access having a combination of the keyword stored in association with the display terminal ID and the URL of the search engine site to the display terminal.

According to the present invention, an operation terminal such as a mobile phone, with which a user is usually familiar, can be used just like a remote controller so as to switch displays and content playback control such as changing playback status (play, forward, rewind) or a volume, on a display terminal such as a television. Here, when a mobile phone of each family member is registered for a set of television, the mobile phone can be used as a pseudo remote controller customized for each family member. By registering a contents list for watching and a search condition for each family member, it is possible to watch a moving image content that is greatly customized to the individual family member.

Further, according to the present invention, a general user can use an operation terminal such as a mobile phone to operate switching of a display or the like on a display terminal such as a large screen display mainly installed in a public place. In other words, by configuring the public terminal so as to accept an input from the user and switch the display, interactivity increases, and moreover, it is also possible to lead to collection of marketing information from information, including an operation history of the user or the like, in accordance with a CRM (Customer Relationship Management: various methods for improving customer satisfaction) processing or the like.

Furthermore, according to the present invention, it is possible to use the operation terminal such as a mobile phone to perform bookmark management of a web page, and to display the content on televisions, PCs, or the like, if needed. In other words, a desired website can be displayed on a screen such as televisions without troublesome keyboard entry, and it is possible to perform bookmark management whenever the user likes.

Still furthermore, according to the present invention, it is possible to input an arbitrary keyword from the operation terminal such as a mobile phone, and to display a result of searching by use of the keyword on televisions, PCs, or the like. In other words, it is possible to display the result of searching and a link to a site on a large screen, without troublesome keyboard entry.

With the above-mentioned configuration, it is possible to provide a device and a system that have enhanced operability for TV viewers and users, and a service by use of the device and the system, in a device for displaying contents that displays various contents such as moving images, still images, and texts.

### BRIEF DESCRIPTION OF THE DRAWINGS

FIG. 1 is a diagram showing the entire configuration of a system according to a first embodiment of the present invention;

FIG. 2 is a diagram showing an example in the prior art, which is described in the first embodiment;

FIG. 3 is a diagram showing a data structure according to the first embodiment;

FIG. 4 is a diagram showing a processing procedure according to the first embodiment at a time of initial setting;

FIG. 5 is a diagram showing a processing procedure according to the first embodiment when a program display is switched;

FIG. 6 is a diagram showing an example of a mobile phone terminal screen (display of a list) according to the first embodiment;

FIG. 7 is a diagram showing an example of a mobile phone terminal screen (display of contents description) according to the first embodiment;

FIG. 8 is a diagram showing an example of a mobile phone terminal screen and a TV screen according to the first embodiment when a program is displayed;

FIG. 9 is a diagram showing the entire configuration of a system according to a second embodiment;

FIG. 10 is a diagram showing an example in the prior art, which is described in the second embodiment;

FIG. 11 is a diagram showing a processing procedure according to the second embodiment at a time of initial setting;

FIG. 12 is a diagram showing processing procedures of a mobile phone terminal and a server according to the second embodiment when a program display is switched;

FIG. 13 is a diagram showing processing procedures of a display terminal and a server according to the second embodiment when a program display is switched;

FIG. 14 is a diagram showing an example of a screen according to the second embodiment at a time of initial setting;

FIG. 15 is a diagram showing an example of a screen according to the second embodiment when a news list is displayed;

FIG. 16 is a diagram showing an example of a screen according to the second embodiment when a content of news is displayed;

FIG. 17 is a diagram showing the entire configuration of a system according to a third embodiment;

FIG. 18 is a diagram showing a processing procedure according to the third embodiment;

FIG. 19 is a diagram showing an example of a mobile phone terminal screen (display of a bookmark) according to the third embodiment;

FIG. 20 is a diagram showing an example of a mobile phone terminal screen according to the third embodiment when a QR Code is read;

FIG. 21 is a diagram showing the entire configuration of a system according to a fourth embodiment; and

FIG. 22 is a diagram showing an example of a screen according to the fourth embodiment.

### DESCRIPTION OF THE PREFERRED EMBODIMENTS

Description will be given below with regard to embodiments of the present invention with reference to the accompanying drawings.

### First Embodiment

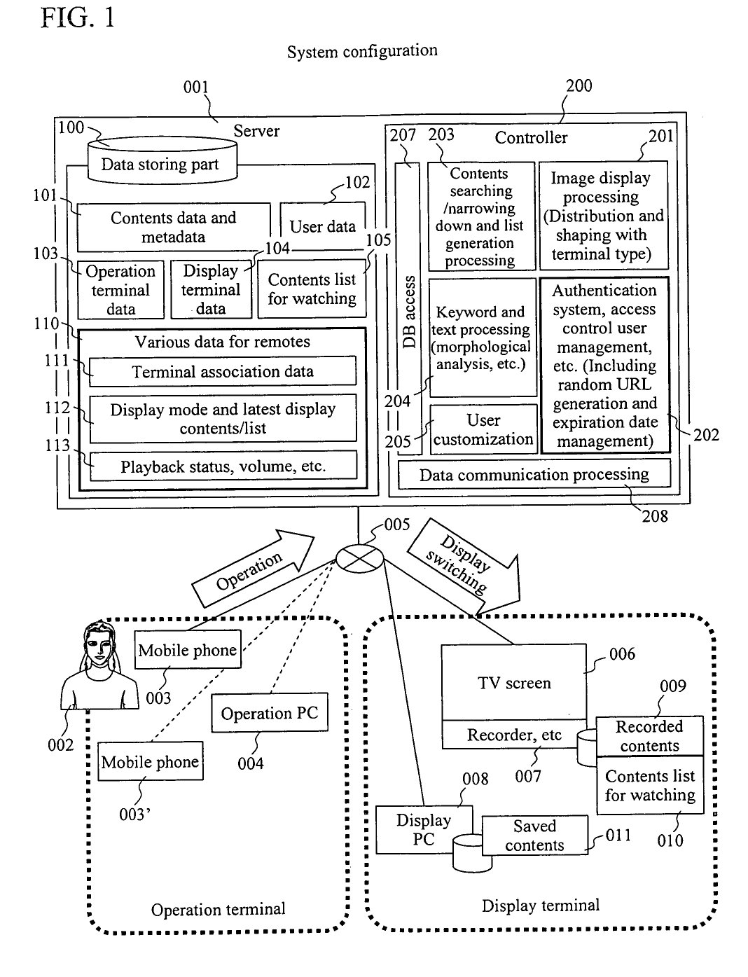

A first example of a system implemented by the present invention will be described referring to FIGS. 1 to 8.

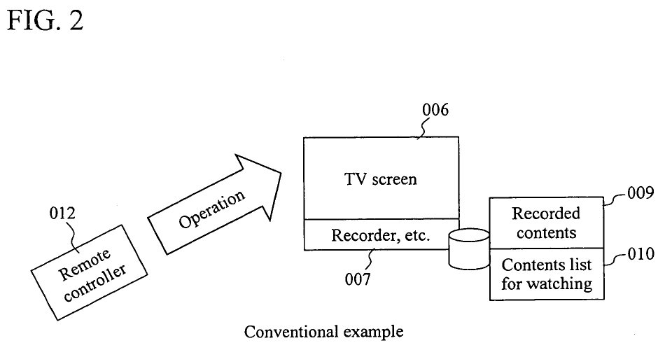

FIG. 1 shows a diagram of a system configuration according to the first embodiment of the present invention. FIG. 2 shows an example of conventional operation on a television.

Conventionally, as shown in FIG. 2, a remote controller 012 has been used to send a command to a moving image reproducer such as a TV screen 006 and a recorder 007 so as to: display a recorded content 009, a contents list for watching 010, or the like on a screen; switch a displayed content; or adjust a volume.

On the other hand, in the first embodiment, as shown in FIG. 1, various operations are performed through a server 001. The server 001 plays a role in connecting an operation PC 004 or a mobile phone 003 carried by a user 002 to the TV screen 006, the recorder 007 or a display PC 008 through a communication network 005 such as the Internet. In other words, when a predetermined operation is performed from an operation terminal such as the mobile phone 003 and the operation PC 004, it is possible to switch the content displayed on the TV screen 006 or the display PC 008, and adjust a playback status and a volume, for example.

The server 001 mainly includes a data storing part 100 and a controller 200. The data storing part 100 includes: content data itself and metadata 101 related to the content data; user data 102 for managing user information; data 103 with regard to the operation terminal and data 104 with regard to the display terminal; a contents list for watching 105 that the user 002 can specify; and various data 110 for a remote. The various data 110 for a remote includes: terminal association data 111 for associating the operation terminal and the display terminal; data 112 with regard to the latest display contents list and a display mode for each display terminal; and data 113 with regard to parameters for playing content such as a playing status (play, forward, rewind, and so on) and a volume for each display terminal. The controller 200 includes: a display processing part 201 that performs distribution and shaping of the display terminal in accordance with a terminal type; a processing part 202 that performs authentication, access control, user management, or the like; a processing part 203 that performs content searching, narrowing down, and list generation processing; a text processing part 204 that performs keyword management, morphological analysis, or the like; a user customizing processing part 205; a database access processing part 207; and a data communication processing part 208.

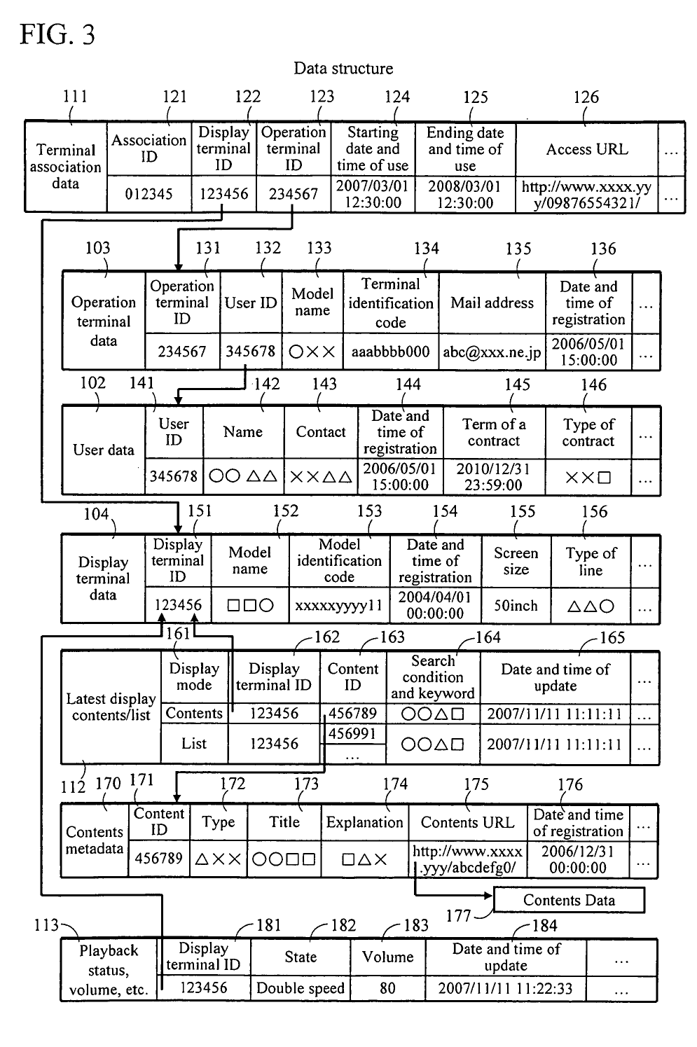

FIG. 3 shows a data structure of a representative data in the data storing part 100 of FIG. 1. The terminal association data 111 includes an ID 122 of the display terminal and an ID 123 of the operation terminal, which are associated with each other, as well as information, such as a date and time 124 when operation is started (association is started), a period 125 during which the operation is accepted (expiration date and time for use), and a URL 126 that the operation terminal accesses for operation. The operation terminal data 103 referred to from the operation terminal ID 123 includes data such as an ID 132 of a user who uses the operation terminal (when the system needs user registration), a model name or model type 133 of the operation terminal, a terminal identification code 134, a mail address 135, and a date and time of registration 136. Here, the terminal identification code is a unique code (often referred to as “individual identification number”) provided for a lot of mobile phone terminals and used for identifying each terminal. Since the terminal identification code can identify which terminal has accessed the server, the terminal identification code is used for authentication by a lot of web services for the mobile phone terminals. Although the model name and model type may be needed for shaping of the screen display, it is not always necessary to store this data. Additionally, personal information such as the mail address is not always necessary for operation of the system, either. When the system is premised on user registration, the user data 102 can be referred to from the user ID 132 stored here. In a case of a system that enables temporary use of the operation terminal without user registration, the user data 102 is not always necessary.

In the user data 102, the personal information (these are not always necessary) such as a name 142 and a contact 143, and a date and time of registration 144 are stored, as well as, if needed, information such as a term of a contract 145 and a contract type 146. Even when connection is made by use of a different terminal, convenience for the user can be greatly improved by storing an access log with an identical user ID, customizing from a viewing history of the contents, or creating a contents list for watching. The display terminal data 104 referred to from the display terminal ID 122 of the terminal association data 111 includes data such as a model name and model type 152, a model identification code 153, a date and time of registration 154, information 155 on screen size for customizing the screen display, and a type of a line 156. When the display terminal belongs to each user, association of the display terminal with the user data 102 is also possible by storing the user ID.

The data 112 with respect to the latest display contents/list is data for storing the contents and list to be displayed by each display terminal together with a mode to display. The data 112 includes information, such as a display mode 161 whether to display a single content or a list display, an ID 162 of the display terminal, an ID (or arrangement) 163 of the contents to be displayed, a search condition and keyword 164 inputted from the operation terminal (when needed), and a date and time of update 165. Metadata 170 of each content is referred to from the content ID 163. The metadata 170 includes a reference 175 to a content body 177 and variety of information related to the content. The data 113 includes an ID 181 of the display terminal and information such as a displayed state 182, a volume 183, a date and time of update 184, etc, and defines the playback status and volume of each display terminal.

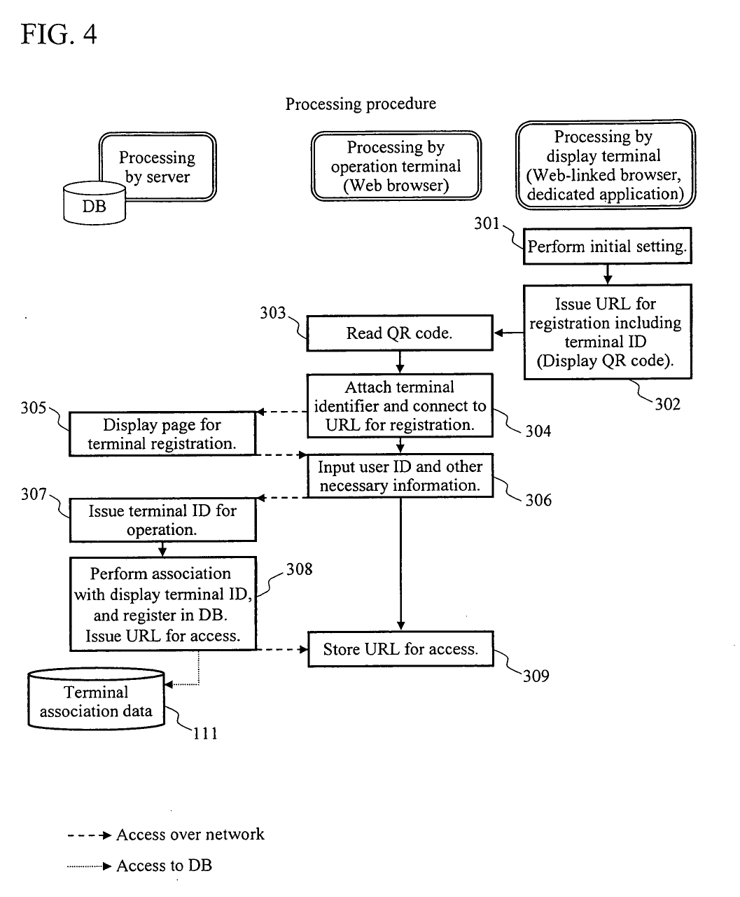

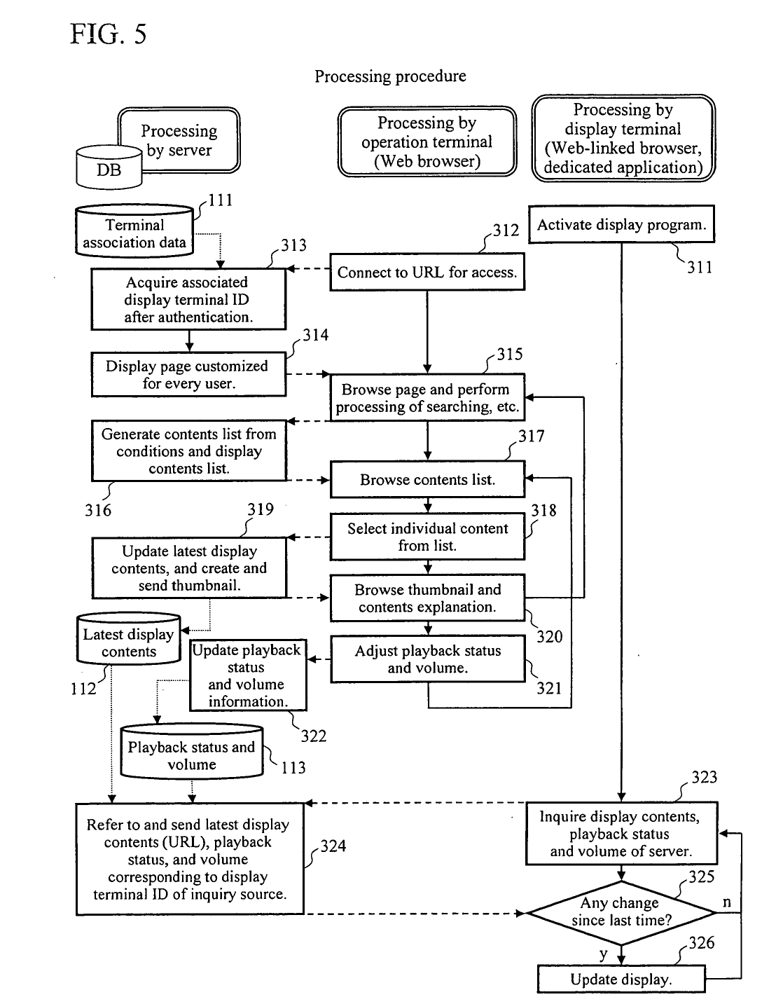

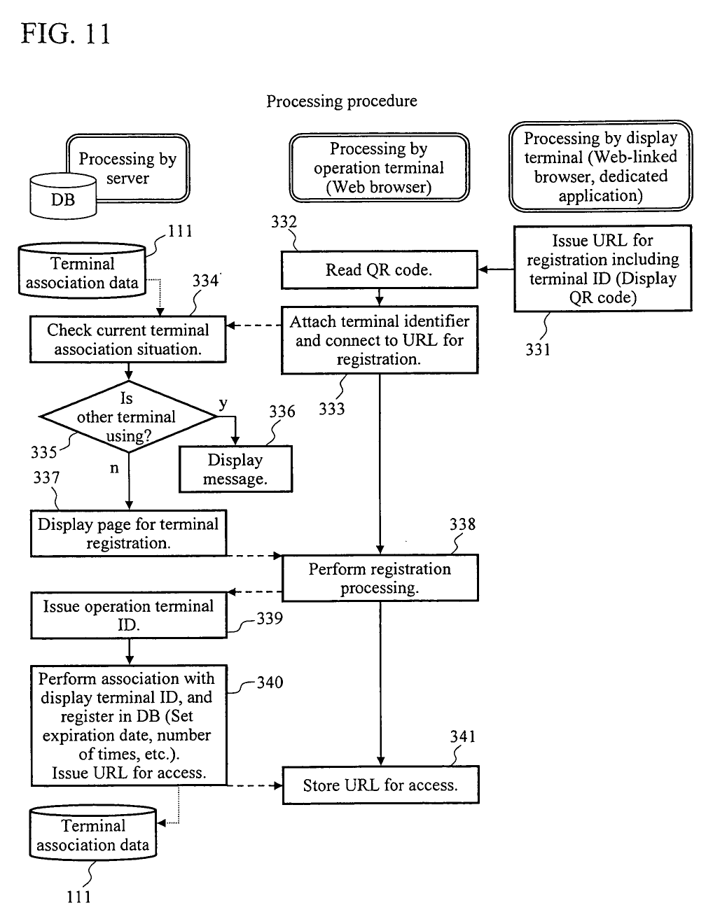

Next, a flow of processing according to the first embodiment of the present invention will be shown in FIGS. 4 and 5. A row on a left side shows processing performed by the server, a middle row shows processing performed by the operation terminal, and a row on a right side shows processing performed by the display terminal. The display terminal accesses the server through a web browser or a dedicated application. Although the operation terminal may have a dedicated application, the operation terminal has higher versatility by accessing the server from a web browser installed in the operation terminal. Here, an arrow with a dashed line indicates access to the server from the operation terminal and the display terminal over the network, and an arrow with a dotted line indicates access to a database within the server (common to FIG. 4, FIG. 5, FIGS. 11 to 13, and FIG. 18).

FIG. 4 shows a processing procedure for newly registering the operation terminal such as a mobile phone and a mobile terminal. To begin with, an “initial setting” is called by performing a predetermined operation on the display terminal (301). A QR Code (two dimensional code in which data of character strings or the like is encoded and is translated into an image; a reading program is installed in a camera-equipped mobile phone or the like; it is possible to access an arbitrary URL or to execute a command by photographing and reading the QR Code; and QR comes from Quick Response) for the initial setting is issued, and displayed on the screen (302). This QR Code includes a URL for registration, the display terminal ID, and other necessary data. When the QR Code is read using the operation terminal (mainly, mobile phone) (303), and the operation terminal accesses the URL for registration with an identification code of the operation terminal itself being attached (304), the server receives the display terminal ID and the terminal identification code of the operation terminal, and starts registration processing. The server displays a page for terminal registration on the operation terminal (305). The operation terminal inputs necessary information and sends the information (306). The server receives the information, issues the operation terminal ID (307), associates the display terminal and the operation terminal, and registers them in the terminal association data 111 of the database. Then, the server issues a URL for access only for the corresponding operation terminal, and presents the URL to the operation terminal (308). The operation terminal performs processing such as storing the URL for access in the bookmark, when necessary (309).

FIG. 5 shows a processing procedure for operating the display terminal by use of the operation terminal. In the display terminal, a display program (web browser or dedicated application) is activated in advance (311). When the operation terminal is connected to the URL for access (312), the server performs an authenticating processing and acquires the ID of the display terminal associated with the operation terminal (313). Then, the server displays a web page customized for each user, such as the contents list and the contents list for watching (314). On the operation terminal, the web page is browsed and processing such as searching is performed (315). In response to an input at this time, the server generates a list of the contents from a condition, and displays the list (316). When the list of the contents is browsed on the operation terminal (317) and an individual content is selected from the list (318), the server updates the latest display contents 112, and displays a thumbnail image, detailed contents information, or the like on a screen of the operation terminal (319). On the operation terminal, the thumbnail and a description of the contents are browsed (320), and the playback status and the volume are adjusted when necessary (321). When the operation terminal sends a command to change the playback status and the volume, the server updates a value of the data 113 with respect to the playback status and the volume (322). On the operation terminal, the flow returns to processing such as displaying the list (317), or inputting a new condition (315), etc. after playback is ended.

On the other hand, the display terminal periodically inquires of the server (323) as to the contents that the display terminal should display and related information thereof. The server refers to the URL of the latest contents and the data such as the playback status and the volume from the display terminal ID, and sends these (324). When the contents (playback status and volume) to be displayed have any change since last time (325), the display terminal updates the display (326). When the contents to be displayed have no change, the display terminal displays the current contents as it is. Here, a series of processing for the display terminal to perform a periodical inquiry of the server and to switch the display depending on the result are implemented by using a dedicated program, or by reading an HTML document into a web browser, the HTML document having an embedded script such as Javascript (script language that operates on a web client like on the web browser). Moreover, similar processing can also be implemented when not the display terminal but the server determines whether the latest display contents are changed from the last display contents.

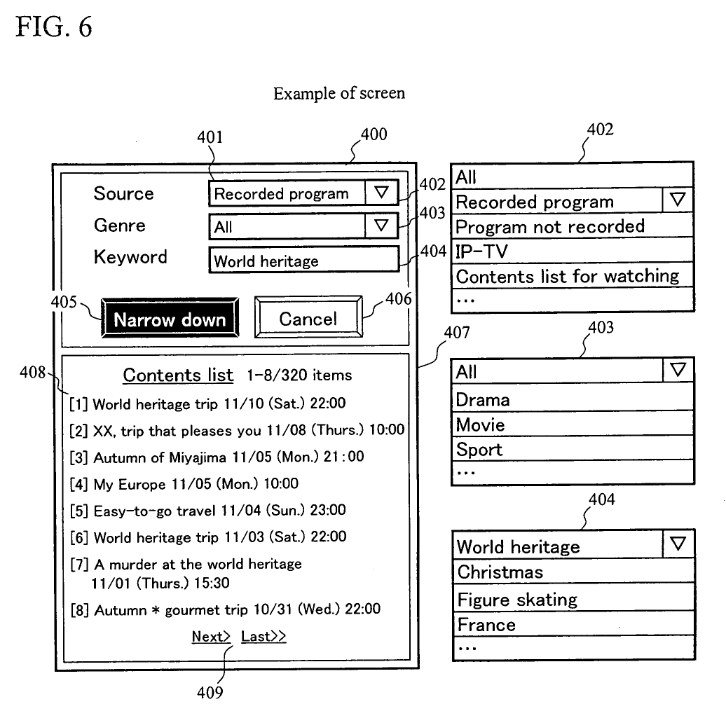

FIGS. 6 to 8 show an example of a screen in the processing shown in FIG. 5.

FIG. 6 shows an example of a screen display of the operation terminal (mobile phone terminal) in Steps 315 to 317 of FIG. 5. A portion 401 for setting to narrow down is disposed in an upper half of a screen 400 of the mobile phone terminal, and a portion 407 for displaying the contents list is disposed in a lower half of the screen 400. In the narrowing down setting, for example, a source 402 of the content, a genre 403, a keyword 404 can be set. Narrowing down is performed by selecting a button 405 to “narrow down.” The source 402 of the content specifies where the content exists (whether the content is a recorded broadcast program and exists in the recorder of the user, or whether the content is the content downloaded via the IP). Here, the “contents list for watching” is a kind of favorite contents list that the user wants or plans to watch. The contents list for watching can be used in many ways. For example, among the contents that exist in various places, the contents are automatically registered in the list in accordance with a predetermined condition; a user registers the content one by one; or another user registers the contents list for watching as a proxy. Registration of the contents list (and assignment of additional information such as a degree of likeness, when needed) allows easy access to the contents that the user wants to watch.

As for the conditions for narrowing down, in addition to the items shown in FIG. 6, conditions can be set, such as a broadcasting date and time, a play count, and a priority set by the user. In a contents list 407 obtained by narrowing down in accordance with these conditions (or simply sorting in accordance with the condition of the date and time or others), a title and link 408 of each content is arranged and displayed. A link or button 409 for switching a page is displayed when necessary.

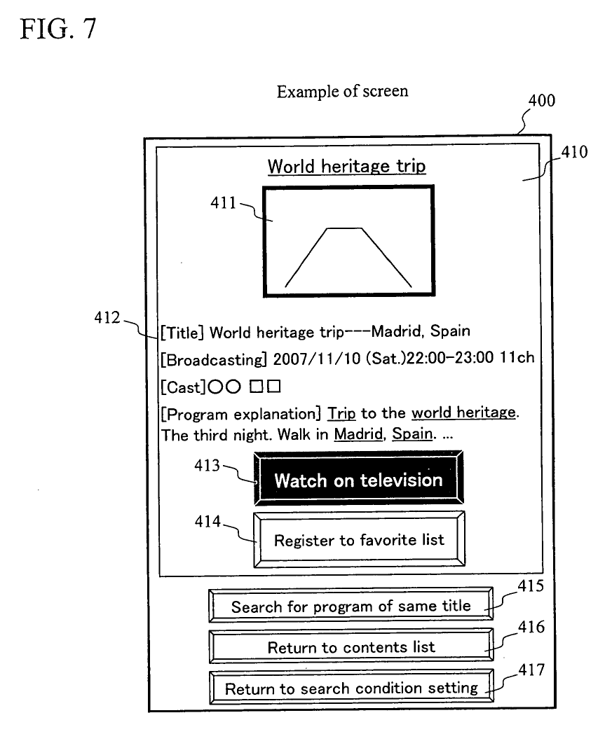

FIG. 7 shows an example of a screen display of the operation terminal (mobile phone terminal) in Step 318 of FIG. 5 (in a state where a content is selected from the list). A thumbnail 411 and a contents explanation 412 are displayed in a contents outline display 410. When a button 413 to “watch on television” is selected here, the corresponding content is displayed on a screen for display. When a button 414 to “register to favorite list” is selected, the content is registered in the contents list for watching of the user as mentioned above, thereby allowing easy reference for the next time. A button 415 for searching for a program of the same title, a button 416 for returning to the contents list, a button 417 for returning to search condition setting, or the like are disposed when necessary to switch the screen.

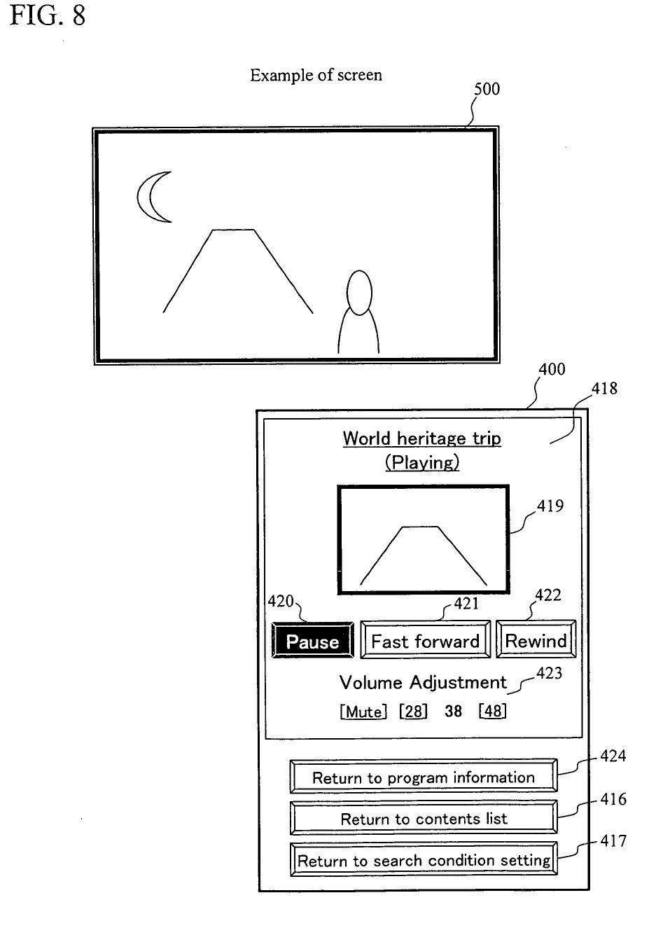

FIG. 8 shows an example of a screen display of the operation terminal (mobile phone terminal) and the display terminal (TV screen) in Steps 319 to 322 of FIG. 5 (content is displayed on the display terminal and various operations are performed). While a display screen 500 of the display terminal displays the content in accordance with the preceding step, the operation terminal displays a thumbnail and moving image 419 of the content that is being watched and other necessary information. The operation terminal also displays manual playback operation buttons, such as a pause button 420, a fast forward button 421, and a rewind button 422, or a link; a volume adjustment button or link 423; and a button 424 for returning to program information. When operation of changing playback status and adjustment of the volume are performed on this screen, a command is sent to the server so that contents playback in the display terminal is controlled.

As mentioned above, the first embodiment of the present invention has been described with reference to FIGS. 1 to 8. In this embodiment, the operation terminal such as a mobile phone is used to perform display switching or operate the playback status, the volume, or the like on the contents (mainly, moving image) display terminal such as a television. When a mobile phone of each family member is registered for one set of television in a household, such a mobile phone can be used as a pseudo remote controller customized to each family member. By registering the contents list for watching and the search condition of each family member, it is possible to watch the moving image content greatly customized to the individual.

### Second Embodiment

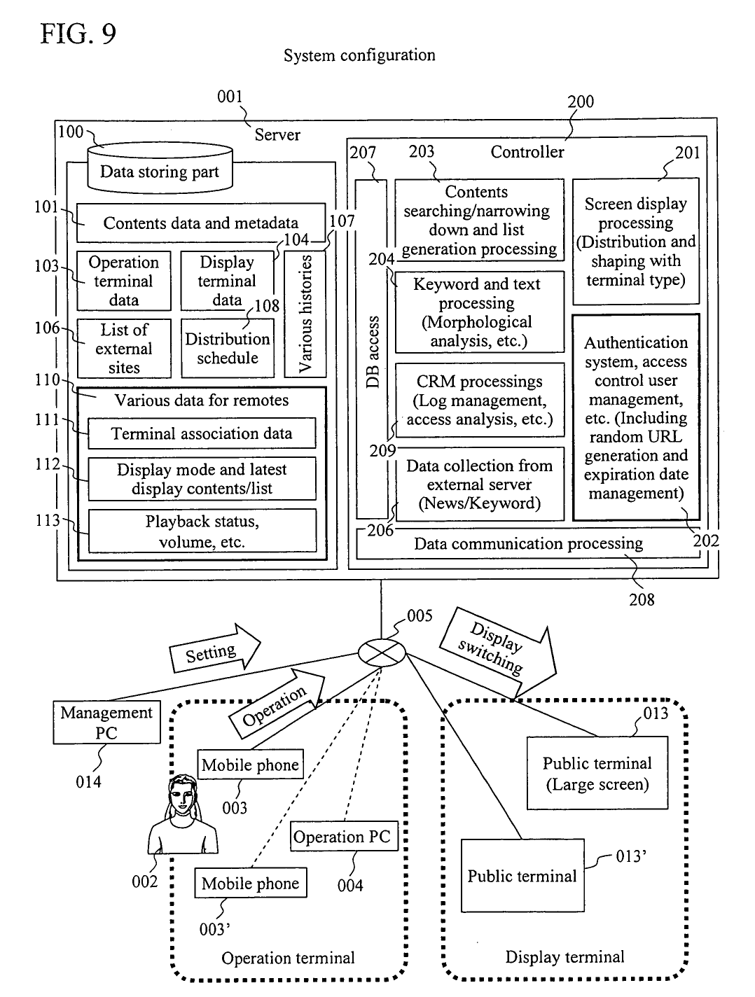

A second embodiment of the system implemented by the present invention will be described referring to FIGS. 9 to 16.

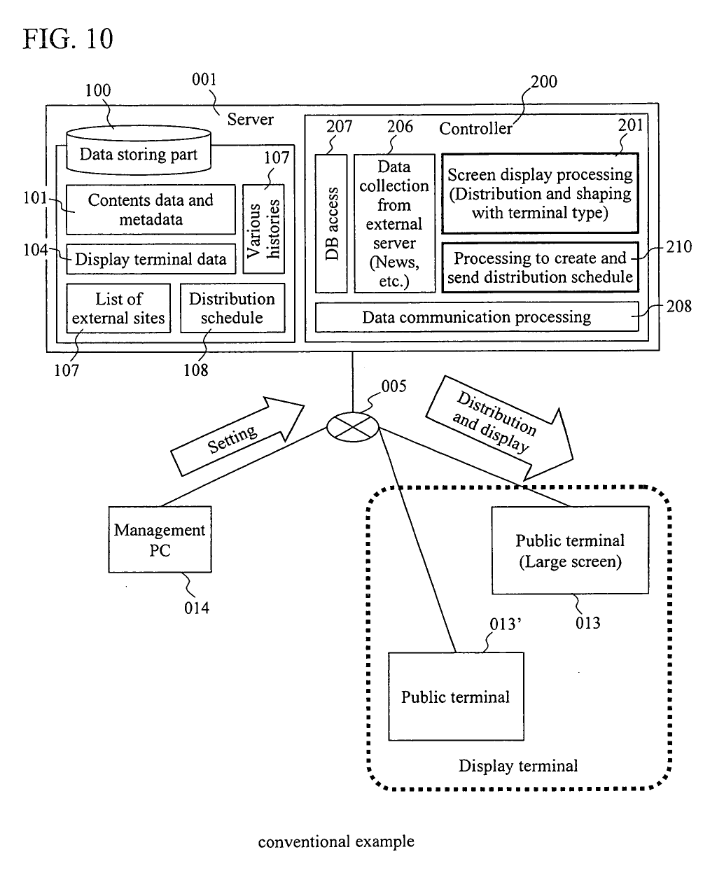

FIG. 9 shows a diagram of a system configuration according to the second embodiment of the present invention. FIG. 10 shows an example of a system for contents distribution and display in a public terminal.

An example in the prior art shown in FIG. 10 is a configuration diagram of the system for distributing content data 101 stored in a server 001 and displaying the content data 101 on a public terminal 013, such as a large screen display installed in a public place, in accordance with a schedule or procedure determined in advance. A management PC 014 performs the setting of contents metadata 101 and a distribution schedule 108 on the server 001 via a network 005. The server 001 performs processing such as collecting the data from an external server in accordance with the distribution schedule, or displaying the contents to be displayed on the display terminal 013. On the other hand, in the second embodiment, as shown in FIG. 9, besides the management PC 014, by using the operation terminal such as a mobile phone 003 carried by a general user 002, it is possible to perform display switching and various operations of the display terminal.

Although the system configuration diagram in FIG. 9 is similar to that of FIG. 1 in the first embodiment, the user data are not stored in the server 001 since the second embodiment is not premised on user registration. The server 001 includes: the distribution schedule 108 for distributing the contents; a processing part 206 for acquiring information such as news and weather reports; a list 106 of external sites; a processing part 209 for performing the CRM processing from an access history or the like; and history data 107 for the CRM processing. The structure of the data included in a data storing part 100 in FIG. 9 is based on that of FIG. 3.

FIGS. 11 to 13 show a flow of processing in the second embodiment of the present invention.

FIG. 11 shows a processing procedure for newly registering the operation terminal such as a mobile phone and a mobile terminal. While the QR Code in which the URL for registration including the display terminal ID is encoded is displayed on the display terminal (331), the QR Code is read by use of the operation terminal (mainly, mobile phone) (332). When the operation terminal accesses the URL for registration with the identification code of the operation terminal itself being attached (333), the server receives the display terminal ID and the terminal identification code of the operation terminal, and starts the registration processing. At this time, the server refers to the expiration date of the terminal association data 111 (time limit, limit by the number of times, or a combination of both limits in some cases) (334). When other operation terminal operates the corresponding display terminal (335), the server displays a message and interrupts registration (336). When the display terminal is vacant, the server displays a page for terminal registration (337). When the operation terminal performs predetermined registration processing (338), the server issues the ID of the operation terminal (339), associates the operation terminal with the display terminal, and registers the operation terminal in the database. At this time, the period of time, the number of times, or the like of valid operation are limited. The server also registers this information in the terminal association data 111. Moreover, the server issues the URL for access, and sends the URL to the operation terminal (340). The operation terminal (temporarily) stores the URL for access in the operation terminal (341).

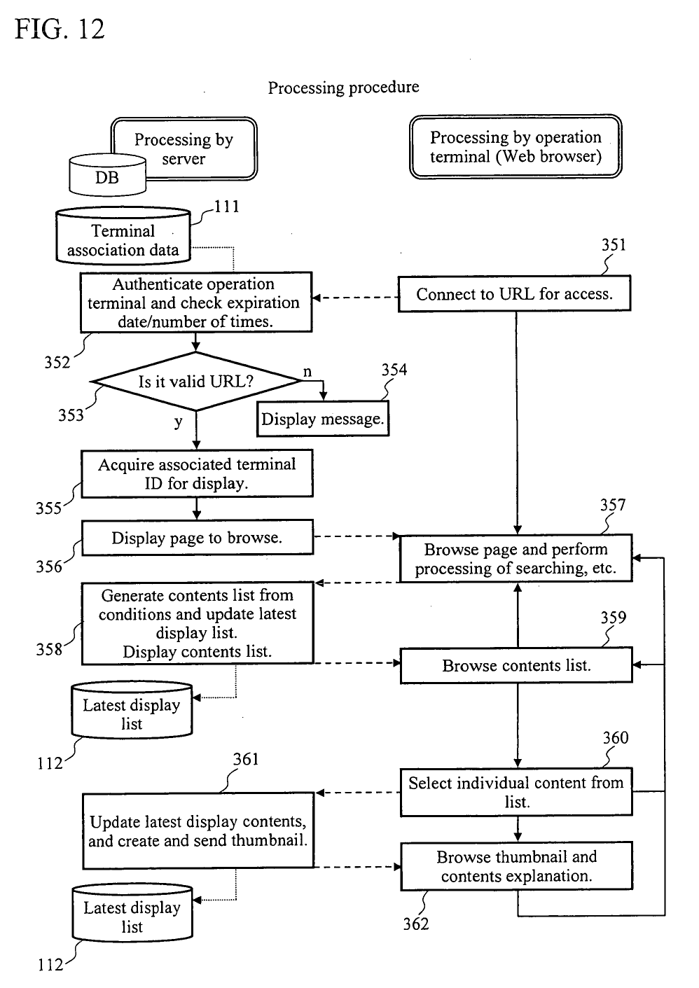

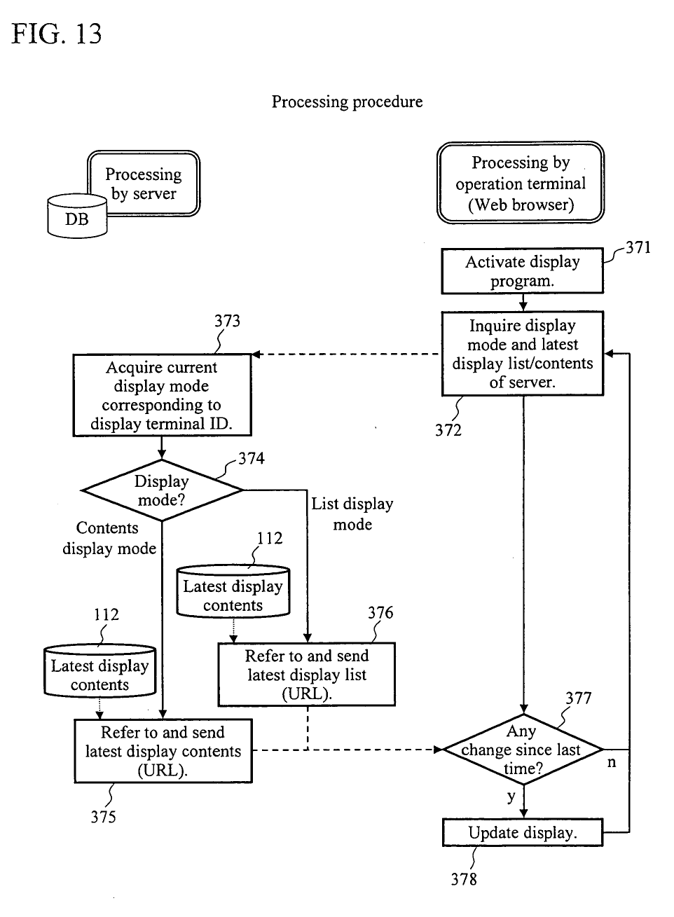

FIGS. 12 and 13 show a processing procedure for operating the display terminal by use of the operation terminal. When the operation terminal is connected to the URL for access (351), the server performs the authentication processing, and from the terminal association data 111, checks whether this operation terminal is valid (352). When the URL is not valid because the period of time and/or the number of times of the valid operation expires (353), the server displays a message and terminates the processing (354). When the association is valid, the server acquires the ID of the associated display terminal (355). Then, in accordance with predetermined processing, the server displays a web page to browse the contents list (356). On the operation terminal, the page is browsed and processing such as searching is performed (357). In response to an input at this time, the server generates a list of the contents from the condition. Then, the server updates the latest display list 112, and simultaneously displays the list on the screen of the operation terminal (358). On the operation terminal, the contents list is browsed (359), and an individual content is selected from the contents list (360). Then, the server updates the latest display contents 112, and displays a thumbnail image, detailed contents information, or the like on the screen of the operation terminal (361). The thumbnail and contents explanation are browsed on the operation terminal (362). The flow returns to processing such as displaying the list (359), or inputting a new condition (357), etc. after playback is ended.

On the other hand, while the display terminal activates a display program (web browser or dedicated application) (371), the display terminal periodically inquires the contents that the display terminal should display of the server (372). The server acquires the current display mode from the display terminal ID (373). In the case of a list display mode, the server sends the latest display list (arrangement of contents URLs) to the display terminal (376). In the case of a contents mode, the server sends a URL of the latest contents to the display terminal (375). When the contents to be displayed have any change since last time (377), the display terminal updates the display (378). When the contents to be displayed have no change, the display terminal displays the current contents as it is. Here, when necessary, the playback status and the volume may be acquired or be changed.

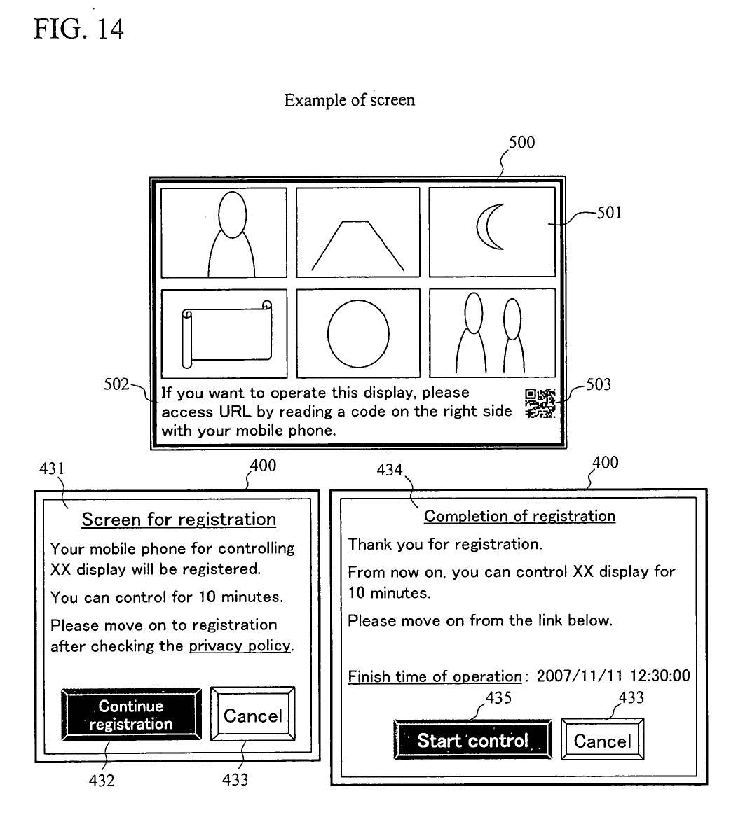

FIGS. 14 to 16 show an example of a screen in the processing shown in FIGS. 11 to 13.

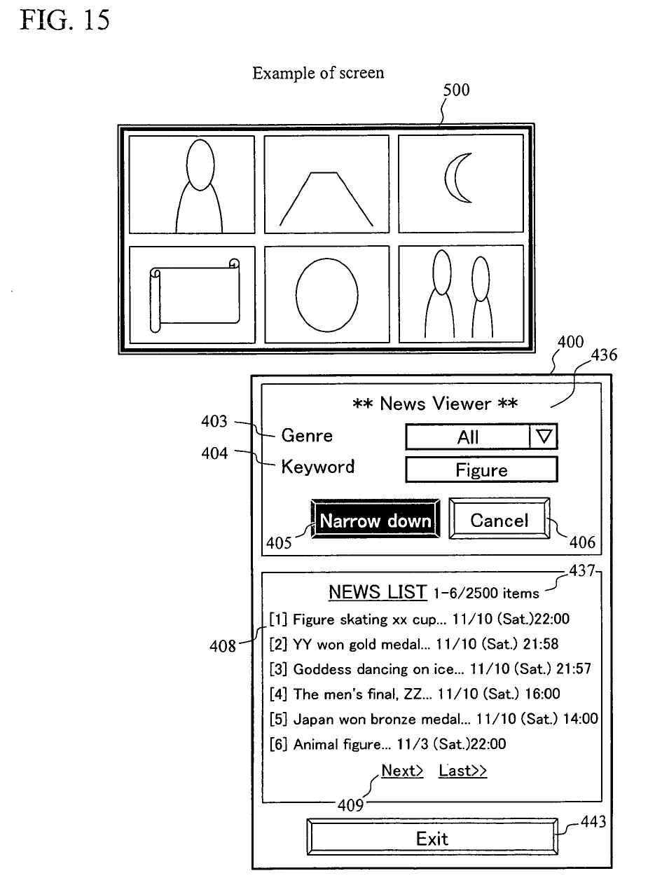

FIG. 14 shows an example of a screen display when registering the operation terminal in FIG. 11. On a screen 500 of the public terminal, a message 502 to prompt the user to register the operation terminal and a QR Code 503 for access are displayed together with a random contents list (news moving image, etc.) 501. Here, when the user photographs this QR Code 503 with his mobile phone so that the mobile phone recognizes the QR Code, and accesses the URL for registration, a registration screen as shown by reference numeral 431 is displayed. When the user selects a registration execution button link 432 (user may go through processing such as filling out an easy questionnaire here), registration is completed so that a registration completion screen 434 is displayed. When the user selects a “control start” button 435 as it is, the user can continuously control the screen (continuing to FIG. 15).

FIG. 15 shows an example of a screen display in Steps 357 to 359 of FIG. 12 (state where the contents list is browsed). A list 437 of the same contents as those displayed on the display screen 500 (here, a list of news) is also displayed on the screen 400 of the mobile phone terminal. Here, it is possible to perform searching/narrowing down and sorting based on varieties of information such as a genre 403 of the news, a keyword 404, a date, and a distributing source. When the conditions are set and a button 405 “to narrow down” is selected, the contents list 437 in a lower part of the screen and also the list on the display screen are updated. Moreover, when an operation end button 443 at the bottom is selected, processing of canceling the terminal association data on the server is performed, thereby, enabling other operation terminal to operate. When the operation is performed exceeding the number of times of the operation recorded in the terminal association data, or when the ending date and time of use expires, the processing of canceling the terminal association data on the server is also performed, thereby, enabling the other operation terminal to operate.

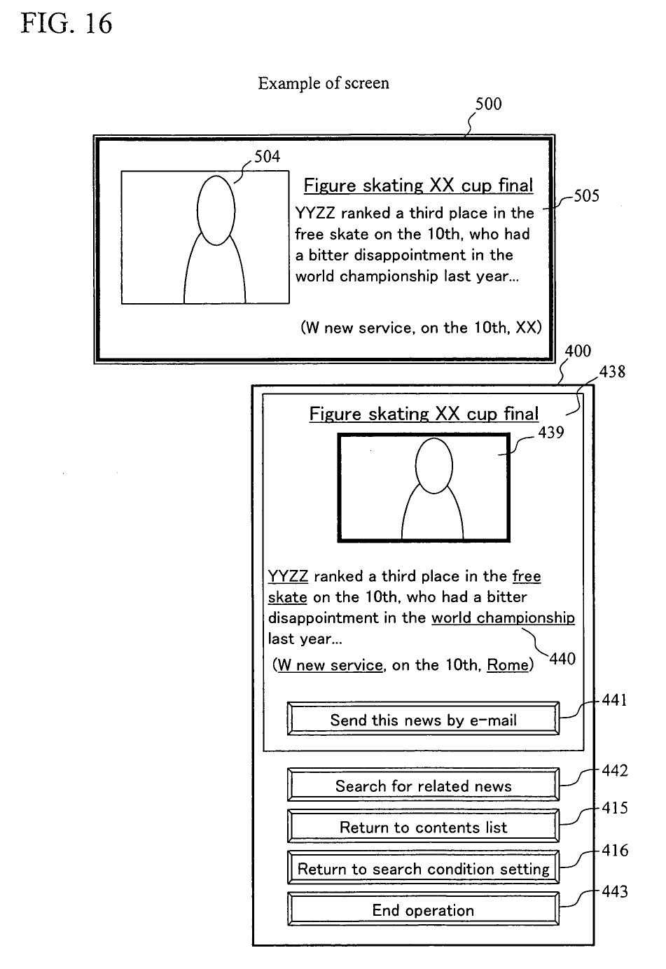

FIG. 16 shows an example of a screen display in Steps 360 to 362 of FIG. 12 (state where an individual content is browsed). Specifically, a piece of the news is selected from the news list 437 of FIG. 15. A thumbnail 439 and news contents 440 of the selected news are displayed on a screen 438 of the operation terminal, while a photograph or moving image 504 and news contents 505 of the same news are displayed also on the display terminal. Besides these, on the operation terminal, a button link 441 for sending the news contents by an e-mail, a button link 442 for searching for related news, or the like are displayed. When a button 415 for returning to the contents list is selected or the list is displayed by performing a new search, the screen will return to the state of FIG. 15.

As mentioned above, the second embodiment of the present invention has been described with reference to FIGS. 9 to 16. In the present embodiment, the general user can use the operation terminal such as a mobile phone to operate switching of the display or the like on the display terminal such as a large screen display mainly installed in a public place. The public terminal, which only unidirectionally distributes and displays the contents in the prior art, can accept an input from the user and switch the display. Thus, interactivity increases, and moreover, it is possible to lead to collection of marketing information from information such as an operation history of the user by using the CRM processing, etc.

Note that although the user registration is unnecessary and the user temporarily operates the display terminal in the present embodiment, it is also possible to construct a system in which a user who has registered in advance can temporarily control the display of the public terminal. In this case, it is also possible to display a contents list and screen customized to an interest and taste of the registered user.

### Third Embodiment

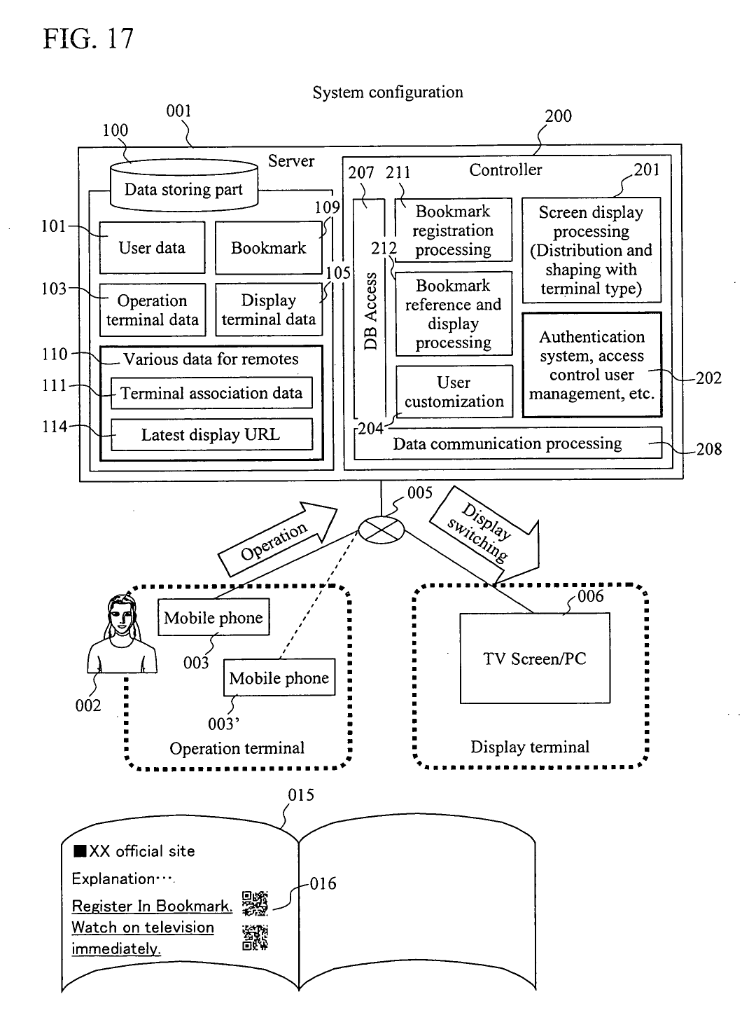

A third embodiment of a system implemented by the present invention will be described referring to FIGS. 17 to 20. In the present embodiment, by use of the operation terminal, a bookmark registered for each user can be managed and browsed, and the content of a web page can be displayed on the display terminal such as a television and a PC.

FIG. 17 shows a diagram of a system configuration according to the third embodiment of the present invention. Although an essential structure is the same as that of FIG. 1, in the present system, bookmark data 109 for each user is stored in a server 001 instead of the contents and the contents list for watching. Processing parts for a bookmark are included, such as a registration processing part 211 and a reference and display processing part 212. The user 002 accesses the server and selects the bookmark using an operation terminal 003 such as a mobile phone. Thus, the URL of the bookmark can be displayed with the web browser of a display terminal 006 such as a television and a PC. Additionally, addition to a bookmark list and update of the bookmark list can be performed by reading a QR Code 016 printed on a paper media 015 such as magazines (or the QR Code 016 displayed on the screen of the display terminal).

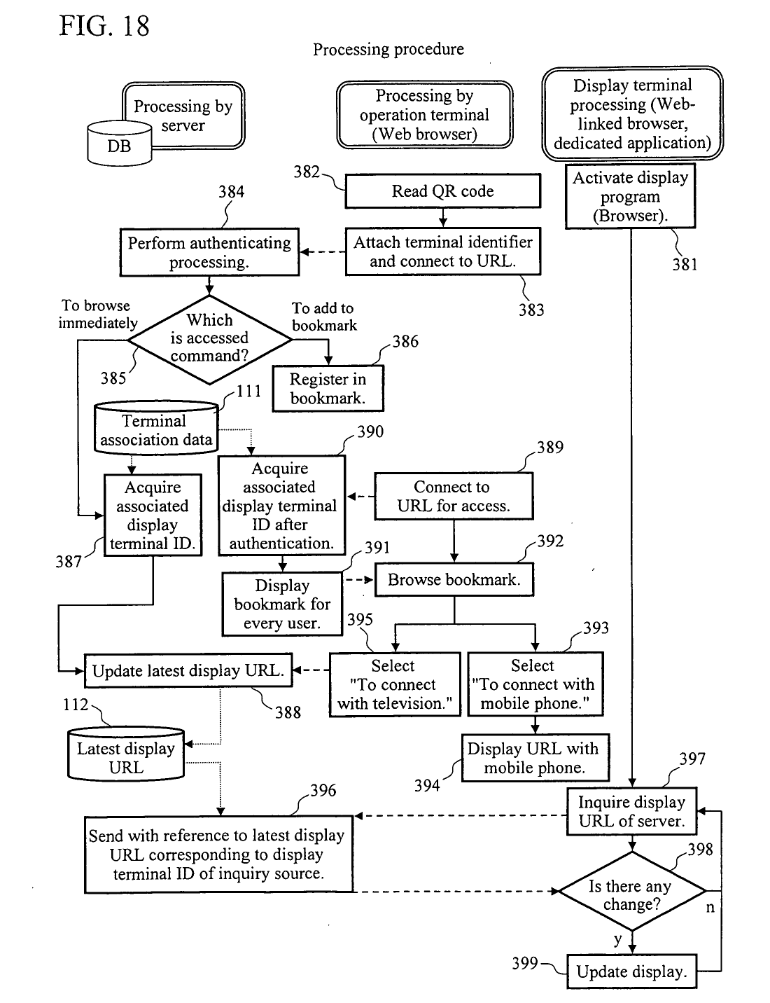

FIG. 18 shows a flow of processing in the third embodiment of the present invention. Since the registration processing of the operation terminal is approximately the same as that of FIG. 4, description thereof will be omitted. In FIG. 18, processing procedures of bookmark registration and reference by use of the operation terminal will be described. Assume that the display program such as the web browser is activated in the display terminal similarly to the above-mentioned embodiments (381). When the operation terminal reads the QR Code displayed on the paper medium or the screen (382), and the operation terminal is connected to the URL with the terminal identification code being attached (383), the server performs the authenticating processing (384), and checks a type of a command included in the URL (385). When the accessed command is to “add to bookmark,” processing to register the corresponding URL in the bookmark of the user is performed (386). When the accessed command is a command to “browse immediately,” first, the server acquires the ID of the display terminal associated with the accessing operation terminal from the association data 111 (387), and updates the data of the latest display URL 112 (388). When the operation terminal accesses a predetermined URL for access (389), the server acquires the ID of the associated display terminal after authentication of the operation terminal (390). The server acquires the bookmark list for each user, and displays the bookmark list on the screen of the operation terminal (391). When the user selects “connect with mobile phone” (393) while browsing the displayed bookmark (392), a URL is displayed on the screen of the mobile phone terminal (394). When the user selects “connect with television” (395), the server updates the data of the latest display URL 112 on the server (388).

The display terminal periodically inquires the URL that the display terminal should display of the server (397). The server sends the latest URL, referring to the latest URL of the display terminal of the inquiry source (396) from the data 112 of the latest display URL. When the URL to be displayed has any change since last time (398), the display terminal updates the display (399). When the URL to be displayed has no change, the display terminal displays the current URL as it is.

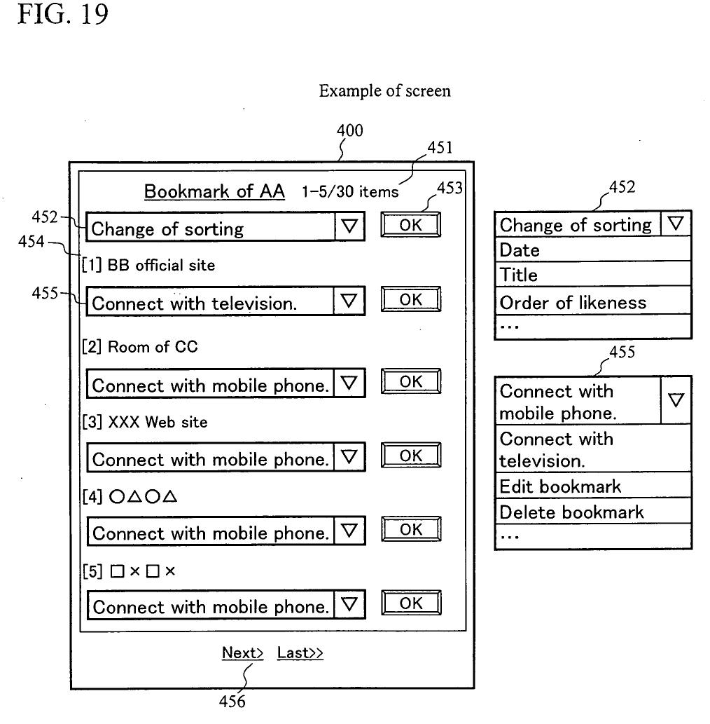

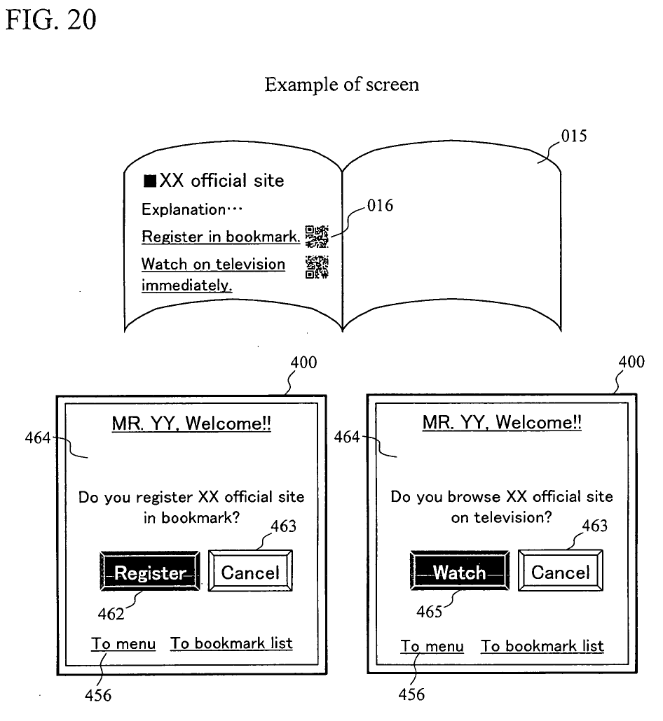

FIGS. 19 and 20 show an example of a screen in the processing shown in FIG. 18.

FIG. 19 shows an example of a screen display in Step 392 of FIG. 18 (state where the bookmark is browsed). A list 451 of the bookmarks is displayed on a screen 400 of the mobile phone terminal. A box 452 and a button 453 for changing the method of sorting, and a page switching link 456 are also displayed. The list can be rearranged in accordance with conditions such as order of a date, a title, and order of likeness. Besides, a narrowing down function in accordance with the conditions, such as contents narrowing down in the first embodiment, may be provided. Each bookmark has a title 454, a box 455 for selecting processing on the bookmark, and a button for performing the processing. The processing on the bookmark includes editing, deletion, etc. of the bookmark as well as “connect with mobile phone,” and “connect with television.” Editing of the bookmark can give a title, a comment, a favorite rank of the bookmark, etc.

FIG. 20 shows an example of a screen display in Steps 382 to 388 of FIG. 18 (bookmark is registered and browsed). The QR Code 016 printed on the paper medium 015 such as magazines (or displayed on the screen of the display terminal) is read by use of the camera-equipped mobile phone. When “register in bookmark” is read, a registration confirmation screen 461 is displayed. When “watch on television immediately” is read, a browsing confirmation screen 464 is displayed. When a “registration” button 462 of the registration confirmation screen is selected, the corresponding bookmark is registered in the bookmark list on the server. When a button 465 of the browsing confirmation screen “watch” is selected, the content of the corresponding URL is displayed on the screen of the associated display terminal.

As mentioned above, the third embodiment of the present invention has been described with reference to FIGS. 17 to 20. In the present embodiment, the operation terminal such as a mobile phone is used to manage the bookmark, and to display the content on televisions, PCs, or the like, when necessary. Thus, it is possible to display a desired website on the screen such as televisions without troublesome keyboard entry, and it is possible to manage the bookmark whenever the user likes.

### Fourth Embodiment

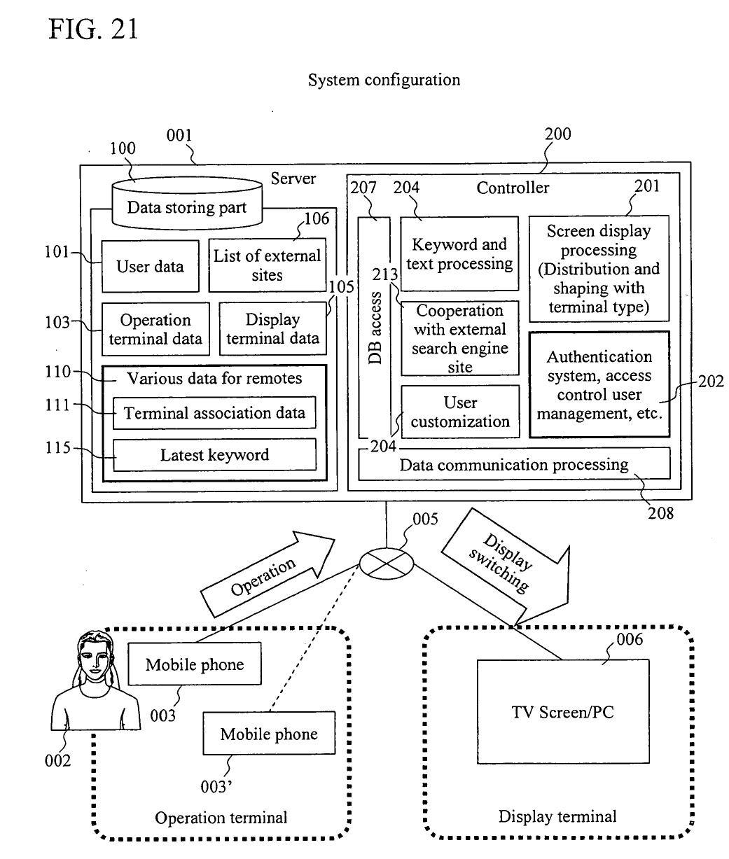

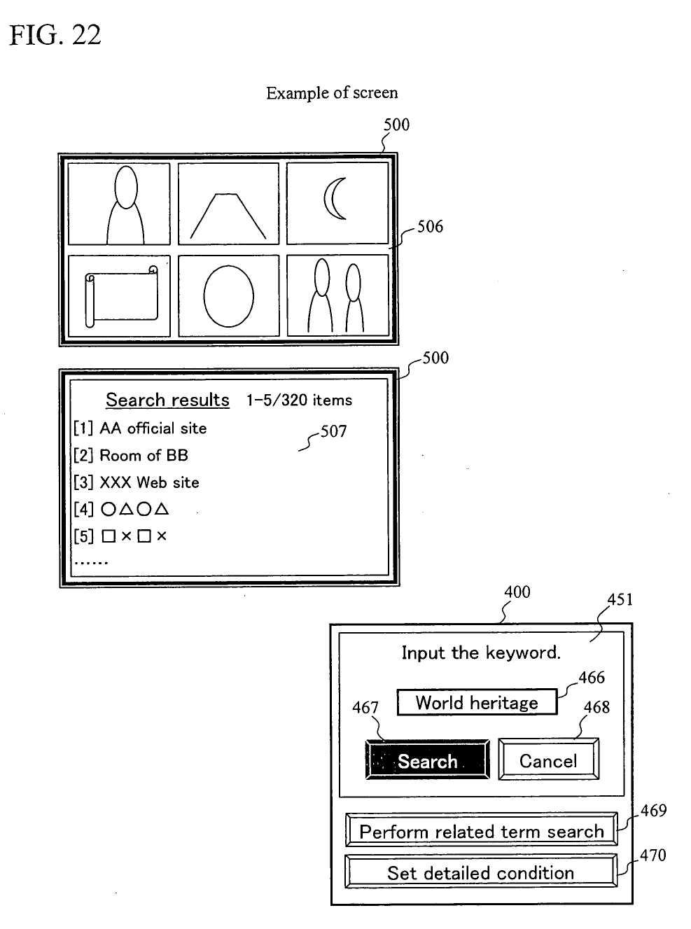

A fourth embodiment of a system implemented by the present invention will be described referring to FIGS. 21 and 22. In the present embodiment, when the user inputs an arbitrary keyword from the operation terminal, the server can perform predetermined search processing, and display the search result on the display screen.

FIG. 21 shows a diagram of a system configuration according to the fourth embodiment of the present invention. Although an essential structure is the same as that of FIG. 17, in the present system, a server 001 manages a latest keyword 115 inputted from the operation terminal instead of the latest URL. The server 001 also has a search engine of its own, or a function 213 to manage cooperation with an external search engine site. When there is an inquiry from the display terminal, the server sends a search result display URL to the display terminal, the search result display URL being a combination of a latest display keyword converted in accordance with a format of a search destination site, when necessary, and a URL of the search destination site. The display terminal receives the search result display URL, and displays a search result by use of the latest keyword on the screen.

FIG. 22 shows an example of a screen display in the fourth embodiment of the present invention. On a screen 400 of the mobile phone terminal, a keyword input box 466, a search button 467, or the like are displayed. Then, on a display screen 500, a list 506 of image search results, a list 507 of site search results, or the like are displayed. A search destination and an option may be set in advance on the server, and may be selected from the operation terminal by the user. Moreover, when the user selects a related term search button 469, the screen goes to a mode in which a new search is performed by use of a keyword related to the current keyword, the keyword is selected from a history of the keywords inputted so far, or the keyword recently often searched for is selected. Conditions such as specification of the search destination can be set by selecting a detailed condition setting button 470.

As mentioned above, the fourth embodiment of the present invention has been described with reference to FIGS. 21 and 22. In the present embodiment, when the arbitrary keyword is inputted from the operation terminal such as a mobile phone, the result of a search by use of the keyword can be displayed on televisions, PCs, or the like. Thus, it is possible to display the search result and the link to the site on the large screen, without troublesome keyboard entry.

Note that although a service premised on user registration has been described in the present embodiment, it is possible to display the search result on the public display terminal without user registration by temporarily associating the operation terminal, as described in the second embodiment.

According to the present invention, it is possible to provide a home terminal such as a television and a PC having enhanced operability and a public terminal that can effectively distribute the contents, and moreover, it is possible to provide a customized service for each user using these terminals.

Additionally, the contents distribution service by use of the public terminal that the user can freely operate can also lead to collection of marketing information from the information such as the operation history of the user in accordance with the CRM processing.

### EXPLANATION OF REFERENCE NUMERALS

001 . . . server, 002 . . . viewer/user, 003 . . . mobile phone, 004 . . . operation PC, 005 . . . network, 006 . . . TV screen, 007 . . . recorder, 008 . . . display PC, 009 . . . recorded contents, 010 . . . contents list for watching, 011 . . . saved contents, 012 . . . remote controller, 013 . . . public (large screen) terminal, 014 . . . management PC, 015 . . . print medium, 016 . . . QR code for access, 100 . . . data storing part, 101 . . . content data and metadata, 102 . . . user data, 103 . . . operation terminal data, 104 . . . display terminal data, 105 . . . contents list for watching, 106 . . . list of external sites, 107 . . . various histories, 108 . . . distribution schedule, 109 . . . bookmark, 110 . . . various data for remotes, 111 . . . terminal association data, 112 . . . display mode and latest display contents/list, 113 . . . playback status, volume, etc., 114 . . . latest display URL, 115 . . . latest keyword, 121 . . . association ID, 122 . . . display terminal ID, 123 . . . operation terminal ID, 124 . . . starting date and time of use, 125 . . . expiration date and time of use, 126 . . . access URL, 131 . . . operation terminal ID, 132 . . . user ID, 133 . . . model name, 134 . . . terminal identification code, 135 . . . mail address, 136 . . . date and time of registration, 141 . . . user ID, 142 . . . name, 143 . . . contact, 144 . . . date and time of registration, 145 . . . term of contract, 146 . . . type of contract, 151 . . . display terminal ID, 152 . . . model name, 153 . . . model identification code, 154 . . . date and time of registration, 155 . . . screen size, 156 . . . type of line, 161 . . . display mode, 162 . . . display terminal ID, 163 . . . content ID, 164 . . . search condition and keyword, 165 . . . date and time of update, 170 . . . contents metadata, 171 . . . content ID, 172 . . . type, 173 . . . title, 174 . . . description, 175 . . . contents URL, 176 . . . date and time of registration, 177 . . . content data, 181 . . . display terminal ID, 182 . . . state, 183 . . . volume, 184 . . . update date, 200 . . . controller, 201 . . . screen display processing, 202 . . . authentication system, access control user management, etc., 203 . . . contents searching/narrowing down and list generation processing, 204 . . . keyword and text processing, 205 . . . user customizing processing, 206 . . . processing of data collection from external server, 207 . . . database access, 208 . . . data communication processing, 209 . . . CRM processing, 210 . . . processing to create and send distribution schedule, 211 . . . bookmark registration processing, 212 . . . bookmark reference and display processing, 213 . . . processing of cooperating with external search engine site, 301 to 309, 311 to 326, 331 to 341, 351 to 362, 371 to 378, 381 to 399 . . . processing steps, 400 . . . mobile phone terminal screen, 401 . . . narrowing down setting part, 402 . . . setting of contents source, 403 . . . setting of genre, 404 . . . setting of keyword, 405 . . . narrowing down execution button, 406 . . . cancel button, 407 . . . contents list display part, 408 . . . contents items, 409 . . . page switching link, 410 . . . contents outline display screen, 411 . . . thumbnail, 412 . . . contents explanation, 413 . . . display switching button, 414 . . . button to register to favorite list, 415 . . . button to search for program of the same title, 416 . . . button to return to contents list, 417 . . . button to return to search condition setting, 418 . . . screen under playing, 419 . . . thumbnail (or moving images), 420 . . . pause button, 421 . . . fast forward button, 422 . . . rewind button, 423 . . . volume adjustment link, 424 . . . button to return to program information, 431 . . . screen for registration, 432 . . . registration execution button, 433 . . . stop button, 434 . . . registration completion confirmation screen, 435 . . . control start button, 436 . . . news narrowing down setting part, 437 . . . news list display part, 438 . . . news contents display screen, 439 . . . thumbnail, 440 . . . text, 441 . . . mail sending button, 442 . . . related news search button, 443 . . . operation end button, 451 . . . bookmark display screen, 452 . . . change of sorting, 453 . . . OK (determination) button, 454 . . . bookmark title, 455 . . . bookmark menu, 456 . . . page switching link, 461 . . . message for registration confirmation, 462 . . . registering button, 463 . . . stop button, 464 . . . message for confirming browsing, 465 . . . browsing execution button, 466 . . . keyword input box, 467 . . . search execution button, 468 . . . stop button, 469 . . . related term search execution button, 470 . . . detailed conditions setting button, 500 . . . television/large screen display, 501 . . . contents list (thumbnail) display, 502 . . . text for registration explanation, 503 . . . QR code for registration, 504 . . . news image (moving image), 505 . . . texts of news contents, 506 . . . list of image search results, 507 . . . list of site search results

What is claimed is:

1. A server for displaying contents, comprising:
a data storing part that stores:
terminal association data in which an operation terminal ID for identifying an operation terminal is associated with a display terminal ID for identifying a display terminal; and
display information in which the display terminal ID is associated with a content to be displayed on the display terminal;
a data communication processing part that performs data communication with the operation terminal and the display terminal through a communication network; and
a controller that performs authentication and access control of the operation terminal, wherein
when there is access from the operation terminal, the controller authenticates the operation terminal with reference to the terminal association data, and acquires the display terminal ID associated with the operation terminal;
in response to a command sent from the operation terminal, the controller stores the content to be displayed in association with the acquired display terminal ID; and
when there is an inquiry from the display terminal, the controller sends to the display terminal the content stored in association with the display terminal ID and a reference destination of the content.

2. The server for displaying contents according to claim 1, wherein when the controller receives the display terminal ID and identification information of the operation terminal through a screen for terminal registration, the controller issues an ID unique to the operation terminal, and registers the terminal association data on the operation terminal in the data storing part.

3. The server for displaying contents according to claim 1, wherein
the operation terminal is a mobile phone terminal, and
the communication processing part performs data communication with the operation terminal and the display terminal through the Internet.

4. The server for displaying contents according to claim 1, wherein
the controller has a screen display processing part, and
the screen display processing part changes the size of an image and arranges the shape of the image depending on each of types of the operation terminal and display terminal.

5. The server for displaying contents according to claim 1, wherein
a content playback parameter associated with the display terminal ID is stored in the data storing part;
when the controller receives the content playback parameter sent from the operation terminal, the controller updates the content playback parameter stored in association with the display terminal ID associated with the ID of the operation terminal; and
when there is an inquiry from the display terminal, the controller sends to the display terminal the content playback parameter stored in association with the ID of the display terminal.

6. The server for displaying contents according to claim 1, wherein
the controller has a content search processing part; and
when a searching and narrowing down condition is received from the operation terminal, the content search processing part searches and narrows down the contents in accordance with the condition, and displays the result on a screen of the operation terminal.

7. The server for displaying contents according to claim 1, wherein
a contents list for watching associated with any one of the operation terminal and a user of the operation terminal is stored in the data storing part;
when the controller receives an instruction to register a content in the contents list from the operation terminal, the controller registers the selected content in the contents list associated with any one of the operation terminal and the user of the operation terminal; and
when the controller receives an instruction to display the contents list from the operation terminal, the controller displays a contents list on the screen of the operation terminal, the contents list being included in the contents list associated with any one of the operation terminal and the user of the operation terminal.

8. The server for displaying contents according to claim 1, wherein the data storing part stores content data for moving image display.

9. The server for displaying contents according to claim 1, wherein the content stored in association with the display terminal ID is any one of a content stored in the display terminal and a content stored in a recorder connected to the display terminal.

10. The server for displaying contents according to claim 1, wherein
content data for moving image display and a distribution schedule are stored in the data storing part, and
at least one of the number of times of accepting operations from the operation terminal as effective operations, and expiration time for use of the operation terminal is registered in the terminal association data.

11. The server for displaying contents according to claim 10, wherein
when the controller receives the identification information of the display terminal ID and the operation terminal through a screen for terminal registration, the controller determines with reference to the terminal association data whether the display terminal is validly associated with a different operation terminal; and
when the display terminal is not validly associated with the different operation terminal, the controller issues a URL for access from the operation terminal, and registers the terminal association data on the operation terminal in the data storing part, the terminal association data including at least one of the number of times of accepting operations from the operation terminal and the expiration time for use of the operation terminal.

12. The server for displaying contents according to claim 10, wherein, in any one of cases where the number of times of accepting operations from the operation terminal exceeds the number of times registered in the terminal association data, and where the registered expiration time for use arrives, the controller invalidates the terminal association data.

13. The server for displaying contents according to claim 10, wherein a history of access to the contents is stored.

14. The server for displaying contents according to claim 1, wherein the content is a URL of a web page.

15. The server for displaying contents according to claim 14, wherein
a bookmark list associated with the operation terminal ID is stored in the data storing part; and
when the controller receives a URL of a web page from the operation terminal simultaneously with a command for adding a bookmark, the controller adds the URL to the bookmark list associated with the operation terminal ID, and
when the controller receives a URL of a web page from the operation terminal simultaneously with a command for browsing, the controller stores the URL in association with the acquired display terminal ID.

16. A server for displaying contents, comprising:
a data storing part that stores:
terminal association data in which an operation terminal ID that identifies an operation terminal, a display terminal ID that identifies a display terminal, and a URL for access by the operation terminal are associated with one another,
a URL of a search engine site, and
data in which the display terminal ID and a keyword to be passed to the display terminal are associated with each other;
a data communication processing part that performs data communication with the operation terminal and the display terminal through a communication network; and
a controller that performs authentication and access control of the operation terminal, wherein
when the operation terminal accesses the URL for access, the controller authenticates the operation terminal with reference to the terminal association data, and acquires the display terminal ID associated with the operation terminal; and
when there is an inquiry from the display terminal, the controller sends to the display terminal a URL of a web page for displaying a search result, the URL being formed of a combination of the keyword stored in association with the display terminal ID and the URL of the search engine site.

17. The server for displaying contents according to claim 16, wherein
the controller sends a keyword input screen to the operation terminal that accesses the URL for access, and
when a keyword is inputted, the controller stores the keyword in association with the acquired display terminal ID.
